(19) United States
(12) Patent Application Publication
(10) Pub. No.: US 2010/0161429 A1
(43) Pub. Date: Jun. 24, 2010

(54) System and Method for Live-Interaction Advertising

(76) Inventor: Edward W. Mandel, Frisco, TX (US)

Correspondence Address: CARSTENS & CAHOON, LLP, P O BOX 802334, DALLAS, TX, 75380, US

(21) Appl. No.: 12/340,195

(22) Filed: Dec. 19, 2008

(51) Int. Cl. G06Q 30/00

(52) U.S. Cl. 705/14.73

(57) ABSTRACT

A system, method, and software for providing live-interaction between a user and an advertising contact in a networked environment. After conducting a search for information over the network, the user is presented with search results in addition to advertisements. The advertisements include hyperlinks to allow the user to communicate with an advertising contact utilizing various methods over the network. For example, the hyperlinks may be email messaging, text messaging, VoIP messaging, or even chat utilities. The user selects a desired hyperlink and an appropriate communications link is established to the advertising contact. The user may then communicate directly to the advertising contact over this link to obtain additional information about the advertised good or service.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to web advertising services, and more specifically to live-interaction advertising systems.

2. Description of Related Art Including Information Disclosed Under 37 CFR 1.97 and 1.98

The more quickly you can get a potential customer in contact with an advertiser, the greater the likelihood that the potential customer becomes a customer. Prior solutions only provide a link to the website or perhaps a phone number or e-mail address in the ad. Or, worse yet, require the potential customer to go to the advertiser's website to search for contact information.

The present invention derives technical advantages because it makes it convenient for the potential customer to contact the advertiser, by allowing the advertisements to contain contact information it easy for the potential customer to use a communication mechanism to discuss the advertisement.

### BRIEF SUMMARY OF THE INVENTION

The present invention provides a system, method, and software to facilitate communications between a user and an advertiser over a computer network. The system provides an advertisement contact module, a mechanism association module, and an icon hyperlink module.

The system performs a method whereby it accepts an advertisement file from an advertiser; associates communications mechanisms with contact information it parses from the advertisement file; generates a hyperlink icon for each communication mechanism and displays the icon in proximity to the advertisement in the user's browser; accepts a communication request from the user; and initiates a communication session between the user and the advertising contact over the selected communication mechanism. The advertising client may be either the advertiser or a designated representative.

The communication mechanism in the present embodiment may be any form of network communication, such as e-mail, messaging, text messaging, VoIP, or the like. Further, the communication mechanism may allow the user and advertising contact to communicate regarding the advertisement in real-time.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 exemplifies a diagram of a live-interaction advertising system in a networked environment, in accordance with principles of the present invention;

FIG. 2 exemplifies a diagram of a method for providing live-interaction advertising, in accordance with principles of the present invention;

FIG. 3 exemplifies a diagram of a method for providing live-interaction with a contact having information about an advertisement, in accordance with principles of the present invention; and

FIG. 4 contains a screen shot of advertisements having live-interaction icons, in accordance with principles of the present invention.

The above figures are provided for the purpose of illustration and description only, and are not intended to define the limits of the disclosed invention. Use of the same reference number in multiple figures is intended to designate the same or similar parts. Furthermore, if and when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning the Internet, digital content, and the like have been omitted inasmuch as such details are not considered necessary to obtain a complete understanding of the present invention, and are considered to be within the skills of persons of ordinary skill in the relevant art.

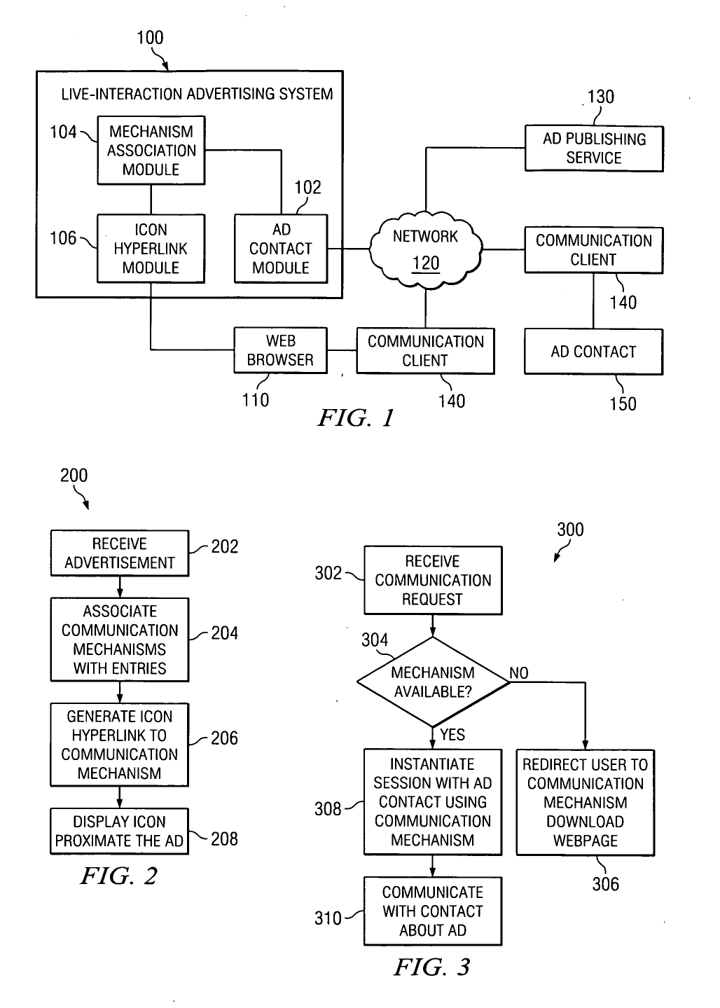

Referring to FIG. 1, there is shown a diagram of a live-interaction advertising system (100) for providing live-interaction with a contact having information about an advertisement over a network, in accordance with principles of the present invention. The system (100) is preferably implemented in hardware, software, or a suitable combination of hardware and software thereof, and may comprise one or more software systems operating on a digital signal processing platform or other suitable processing platforms.

As used herein, “hardware” can include a combination of discrete components, an integrated circuit, a microprocessor, a controller, a microcontroller, an application-specific integrated circuit (ASIC), an electronic data processor, a computer, a field programmable gate array, or other suitable hardware connectable for interfacing with a network, such as the Internet, considered to be well-known in the art. As used herein, “software” can include one or more objects, agents, threads, lines of code, subroutines, separate software applications, two or more lines of code or other suitable software structures operating in two or more software applications or on two or more processors, or other suitable hardware structures. Furthermore, it is considered that the design, development, and implementation details of all such hardware and software would be apparent to a person having ordinary skill in the art based upon a review of the present description of the invention. In one embodiment, software can include one or more lines of code or other suitable software structures operating in a general purpose software application, such as an operating system, and one or more lines of code or other suitable software structures operating in a specific purpose software application.

The system (100) is operably coupled to web-browser (110), advertisement publishing service (130), and advertisement contact (150) by network (120). The network can be a WAN, MAN, LAN, PAN, or any combination thereof. The system (100) is adapted to receive a communication request to provide live-interaction with a contact having information about an advertisement displayed in web-browser (110) and generates HTML code adapted to instantiate a communication client (140) associated with advertisement contact information. The system (100) in this embodiment also includes advertisement contact module (102), mechanism association module (104), and icon hyperlink module (106).

The advertisement contact module (102) is adapted to receive advertisements from the advertisement publishing service (130) and parse out the information contained in the advertisement. In one embodiment, the advertisements are received as an XML transaction. In a second embodiment, the advertisements are received as a JSON transaction. In a third embodiment, the advertisement information parsed is contact information for the advertiser. The contact information can include entries such as an e-mail address or generated e-mail address alias (for privacy), instant messaging address, text messaging number, VoIP Internet number, and other suitable contact information. The advertisement contact module (102) can be achieved with an application programming interface (API), a network connection, a network transfer protocol, HTML, DHTML, JavaScript, Dojo, Ruby, Rails, other suitable formats and applications, or a suitable combination thereof.

The mechanism association module (104) is adapted to receive the contact information from the advertisement contact module (102) and associate each contact entry with a communication mechanism. In one embodiment, the communication mechanism associated with the e-mail address can be MS Outlook, Thunderbird, Mail, Pine, or any other suitable e-mail application. In a second embodiment, the communication mechanism associated with the instant messaging address can be Yahoo! Messenger, MSN Messenger, AIM, ICQ, Gtalk, or any other suitable instant messaging application. In a third embodiment, the communication mechanism associated with the text messaging number can be an SMS client, an MMS client, a WAP Push client, or any other suitable text messaging clients. In a fourth embodiment, the communication mechanism associated with the VoIP Internet number can be Skype, Gizmo Project, Jajah, Truphone, Fring, or any other suitable VoIP applications. Once every contact entry is associated, the mechanism association module (104) associates an icon with each contact entry.

In a fifth embodiment, the communication mechanism is associated with the contact entry by assigning entry fields associated with the contact entry with communication mechanisms according to stored association data, where each field is assigned an association code. The association code contains the specific code segment necessary to instantiate the associated communication mechanism, such as ‘ymsgr:sendim?’ for Yahoo! Messenger. In a sixth embodiment, the icon is associated with the contact entry by assigning a URL pointing to the icon to the contact entry. The mechanism association module (104) can be achieved with an application programming interface (API), a network connection, a network transfer protocol, HTML, DHTML, JavaScript, Dojo, Ruby, Rails, other suitable formats and applications, or a suitable combination thereof.

The icon hyperlink module (106) is adapted to generate code to display an icon associated with the associated communication mechanism in the application. The icon is a hyperlink to the communication mechanism. In one embodiment, an HTML anchor tag is generated having the association code and the associated contact entry. In a second embodiment, an HTML image tag is generated having the URL to the icon. In a third embodiment, the anchor tag envelopes the image tag to generate a hyperlinked icon, which instantiates the communication mechanism with the advertisement's contact entry. The HTML code can be similar to:

<a href = ‘ymsgr:sendim?Contact_Entry’>
<img src=“http://messenger.yahoo.com/displayimages/messenger.gif”>
</a>

In a fourth embodiment the hyperlink includes onClick events. The icon hyperlink module (106) can be achieved with an application programming interface (API), a network connection, a network transfer protocol, HTML, DHTML, JavaScript, Dojo, Ruby, Rails, other suitable formats and applications, or a suitable combination thereof.

Referring now to FIG. 2, there is shown a flow chart (200) exemplifying control logic embodying features of a method for providing live-interaction advertising in accordance with principles of the present invention. The search result formatting control logic (200) can be implemented as an algorithm on a general purpose computing platform or other suitable microprocessor-based system.

The search result formatting control logic (200) can leverage the ability of a computer platform to spawn multiple processes and threads by processing data simultaneously. The speed and efficiency of the live-interaction advertising control logic (200) is greatly improved by instantiating more than one process to generate code to allow a user to communicate with a contact regarding an advertisement. However, one skilled in the art of programming will appreciate that use of a single processing thread may also be utilized and is within the scope of the present invention.

The live-interaction advertising control logic (200) process flow of the present embodiment begins at step 202, where and advertisement is received. In one embodiment, the advertisement contains contact information associated with the advertiser. The contact information can include entries such as an e-mail address or generated e-mail address alias (for privacy), instant messaging address, text messaging number, VoIP Internet number, and other suitable contact information. In a second embodiment, the advertiser may elect to provide the contact information of a call center, which can provide information relevant to the advertisement. The logic then proceeds to step 204.

At step 204, communication mechanisms are associated with contact entries. In one embodiment, the communication mechanism is associated with the contact entry by assigning an entry field associated with the contact entry with a communication mechanism according to an association file, which contains each field and its assigned association code. The association code contains the specific code segment necessary to instantiate the associated communication mechanism. The logic then proceeds to step 206.

At step 206, code is generated to display the icon associated with the associated communication mechanism in the application. In one embodiment, the anchor tag envelopes the image tag to generate a hyperlinked icon, which instantiates the communication mechanism with the advertisement's contact entry. The logic then proceeds to step 208.

At step 208, code is generated to display the icon associated with the associated communication mechanism in the application proximate the advertisement. In one embodiment, the icons associated with the advertisement are disposed below the advertisement.

Referring now to FIG. 3, there is shown a flow chart (300) exemplifying control logic embodying features of a method for providing live-interaction with a contact having information about an advertisement, in accordance with principles of the present invention. The live-interaction control logic (300) can be implemented as an algorithm on a general purpose computing platform or other suitable microprocessor-based system.

The live-interaction control logic (300) process flow of the present embodiment begins at step 302, where a communication request is received. In this embodiment, the user enters a search query through the application. A sponsored advertisement is displayed. The user seeing something in the advertisement that interests him clicks on the icon to initiate immediate communication with the advertiser or a representative of the advertiser regarding the advertisement. The logic then proceeds to step 304.

At step 304, a determination is made as to whether the communication mechanism selected by the user is available to the user. If the communication mechanism is available to the user, the logic proceeds to step 308. If the communication mechanism is not available to the user, the logic proceeds to step 306.

At step 306, the user is redirected to a webpage where the user can download the communication mechanism. Once the user installs the appropriate communication mechanism, the user can restart the control logic beginning at step 302.

At step 308, a live-interaction session is instantiated using the communication mechanism. In one embodiment, the user selected a Yahoo! Messenger icon and a new Yahoo! Messenger chat window appears in a pop-up window with a representative associated with the advertisement. In a second embodiment, the representative is the advertiser, who can answer questions regarding the advertisement. In a third embodiment, the representative is a third party that represents the advertiser and can answer questions regarding the advertisement. In a fourth embodiment, the representative can be a chatbot, a chatterbot, a virtual agent, a virtual employee, or other suitable virtual representative, programmed to answer questions regarding the advertisement. The logic then proceeds to step 310.

At step 310, the user communicates with the representative about the advertisement in real-time.

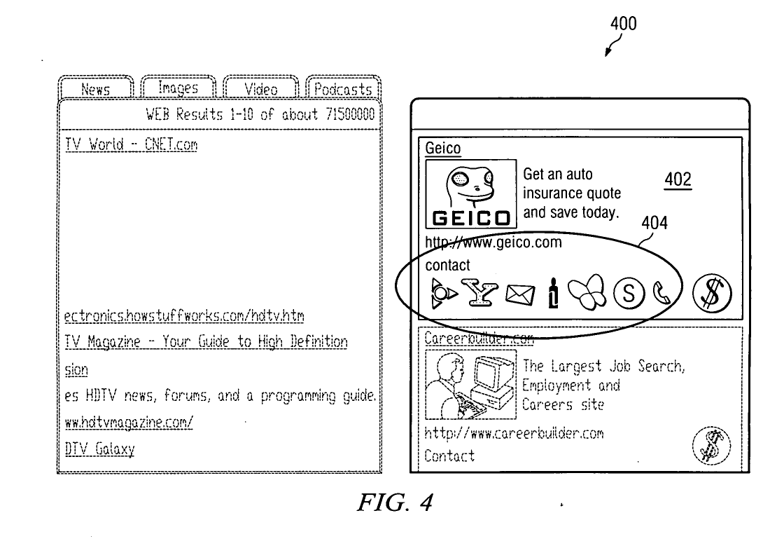

Referring now to FIG. 4, there is shown at 400 a screen shot of a web-browser rendering an advertisement (402) and live-interaction icons (404) associated with the advertisement, in accordance with principles of the present invention. Only the icons associated with the contact information of the advertisement will be displayed. By means of example and not of limitation, if a particular advertisement provides merely an e-mail address and a Windows Live Messenger username, only icons associated with those two communication mechanisms will be displayed. In another example, if the advertisement contains an e-mail address, a Skype Internet number, and a Gtalk username, likewise only those three communication mechanisms will be displayed.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

I claim:

1. A method for providing live interaction in a networked environment between a user and an advertiser through the user's HTML browser, the method steps comprising:
accepting an advertisement file from the advertiser, wherein the advertisement file comprises an advertisement and contact information directed to an advertising contact that is associated with the advertiser;
associating one or more communication mechanisms with the contact information;
generating at least one hyperlink icon for each communication mechanism, wherein the communication mechanism may be accessed via the respective at least one hyperlink icon;
displaying, to the user, the hyperlink icon in proximity to the advertisement in a browser window;
accepting a communication request from the user, wherein the communication request is triggered by the user's selection of a hyperlink icon for a particular communication mechanism; and
initiating a communication session between the user and the advertising contact via the communication mechanism.

2. The method of claim 1, the method steps further comprising:
redirecting the user to a communication mechanism download utility if the selected communication mechanism is not available in the user's browser application.

3. The method of claim 1 wherein the contact information is chosen from the group consisting of an e-mail address, an e-mail address alias, an instant messaging address, a text messaging number, and a VoIP Internet number.

4. The method of claim 1 wherein the communication mechanism is associated with the contact information by assigning an entry field with a communication mechanism according to stored association data, wherein the stored association data contains the field and an assigned association code, and wherein the association code contains a specific code segment necessary to instantiate the associated communication mechanism.

5. The method of claim 1 wherein the communication session allows the user and advertising contact to communicate in real-time.

6. The method of claim 1 wherein the advertising contact is a virtual representative.

7. The method of claim 1, the method steps further comprising:
providing, for display in the user's browser, search results obtained in response to a search request for information on the network conducted by the user.

8. The method of claim 7, the method steps further comprising:
displaying the advertisement and associated hyperlink icons in proximity to the search results.

9. A computer software program tangibly embodied in a computer readable medium, the program including machine-readable instructions executable by a computer processor to perform a method for providing live interaction in a networked environment between a user and an advertiser through the user's HTML browser, the program steps comprising:
accepting an advertisement file from the advertiser, wherein the advertisement file comprises an advertisement and contact information directed to an advertising contact that is associated with the advertiser;
associating one or more communications mechanisms with the contact information;
generating at least one hyperlink icon for each communication mechanism, wherein the communication mechanism may be accessed via the respective at least one hyperlink icon;
displaying, to the user, the hyperlink icon in proximity to the advertisement in a browser window;
accepting a communication request from the user, wherein the communication request is triggered by the user's selection of a hyperlink icon for a particular communication mechanism; and
initiating a communication session between the user and the advertising contact via the communication mechanism.

10. The computer software program of claim 9, the program steps further comprising:
redirecting the user to a communication mechanism download utility if the selected communication mechanism is not available in the user's browser application.

11. The computer software program of claim 9 wherein the contact information is chosen from the group consisting of an e-mail address, an e-mail address alias, an instant messaging address, a text messaging number, and a VoIP Internet number.

12. The computer software program of claim 9 wherein the communication mechanism is associated with the contact information by assigning an entry field with a communication mechanism according to stored association data, wherein the stored association data contains the field and an assigned association code, and wherein the association code contains a specific code segment necessary to instantiate the associated communication mechanism.

13. The computer software program of claim 9 wherein the communication session allows the user and advertising contact to communicate in real-time.

14. The computer software program of claim 9 wherein the advertising contact is a virtual representative.

15. The computer software program of claim 9, the program steps further comprising:
providing, for display in the user's browser, search results obtained in response to a search request for information on the network conducted by the user.

16. The computer software program of claim 15, the program steps further comprising:
displaying the advertisement and associated hyperlink icons in proximity to the search results.

17. A system for providing live interaction between a user and an advertiser over a computer network through the user's HTML browser, the system comprising:
an advertisement contact module, wherein the advertisement contact module receives an advertisement file from an advertisement publishing service, and wherein the advertisement contact module parses the advertisement file to obtain contact information related to an advertising contact;
a mechanism association module, wherein the mechanism association module receives the contact information and associates each unit of contact information with an appropriate communication mechanism; and
an icon hyperlink module, wherein the icon hyperlink module generates at least one hyperlink icon for each communication mechanism and associates each generated hyperlink icon with its respective communication mechanism.

18. The system of claim 17, the system further comprising:
a communication client, wherein the communication client initiates communication between the user and the advertising contact.
